(19) United States
(12) Patent Application Publication
(10) Pub. No.: US 2011/0100677 A1
(43) Pub. Date: May 5, 2011

(54) FIBER-POLYMER COMPOSITE

(75) Inventors: Buo Chen, Hillsborough, NJ (US); Dirk B. Zinkweg, Katy, TX (US)

(73) Assignee: Dow Global Technologies Inc., Midland, MI (US)

(21) Appl. No.: 13/001,665

(22) PCT Filed: Jun. 30, 2009
(86) PCT No.: PCT/US09/49237

§ 371 Date: Dec. 28, 2010

Related U.S. Application Data
(60) Provisional application No. 61/077,327, filed on Jul. 1, 2008.

(51) Int. Cl. H01B 5/10

(52) U.S. Cl. 174/126.2

(57) ABSTRACT

The present invention is a fiber-polymer composite-supported conductor with a fiber-polymer composite core and a tubular metal conductor. The tubular metal conductor is on the core. Substantially all mechanical tension resulting from the disposition of the conductor is borne by the fiber-polymer composite core.

The invention relates to supported overhead power cables. Specifically, the invention relates to fiber-polymer composite-supported overhead power cables.

Currently, bare aluminum conductor overhead wires such as aluminum conductor steel reinforced (ACSR) and aluminum conductor steel supported (ACSS) are constructed with a steel core to carry their weight. Fiber reinforced polymeric composite materials can be used to replace the steel core.

Fiber reinforced polymeric composite materials can provide advantages regarding weight and strength. On the other hand, polymeric composite materials also have disadvantages regarding fatigue durability, torsional strength, and surface fretting resistance. Because overhead wires should have a service life exceeding 60 years, resolving fatigue, torsional strength, and surface fretting issues are critical to the usefulness of alternatives to steel core wire.

There is a need to provide an aluminum conductor fiber-polymer composite supported overhead wire that overcomes the disadvantages associated with fatigue, torsion, and surface fretting resistance. Additionally, the fiber reinforced polymeric composite core should demonstrate mechanical properties sufficient to satisfy ASTM B 341/B 341M-02 and have high elongation and high modulus. The composite core should also demonstrate high temperature resistance and high fracture toughness. There is also need to reduce the complexity of the pultrusion process by pre-forming the loose continuous fibers into specific microstructures prior to pultrusion. Furthermore, it is desirable to replace steel cores with lighter and stronger synthetic materials (i.e., higher strength to weight ratios).

While the aluminum conductor fiber-polymer composite support should be sufficient to address the overhead needs, a person of ordinary skill in the art would readily recognize the usefulness of the support for other applications, including submarine fiber optical cable.

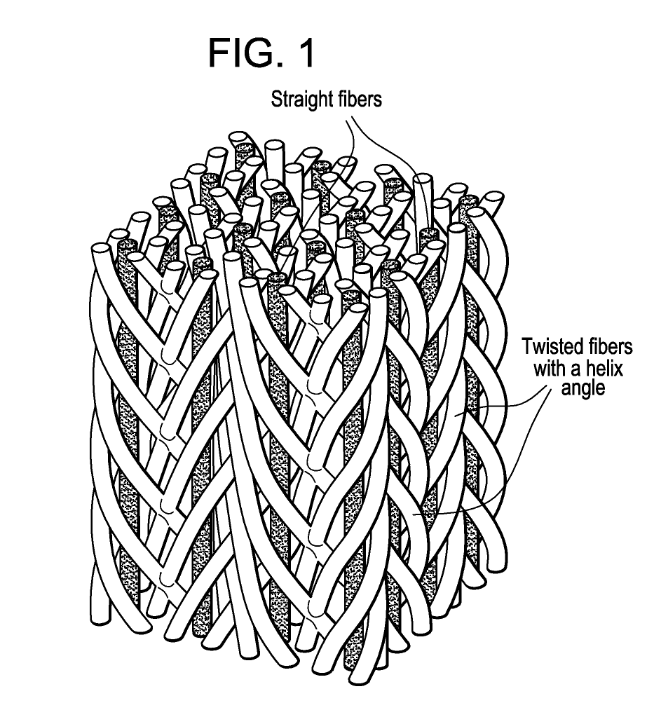

FIG. 1 shows a microstructure of the invented fiber-polymer composite, wherein the microstructures consist of axial fibers aligned in the longitudinal direction of the core as well as twisted fibers braided around the axial fibers with certain helix angles.

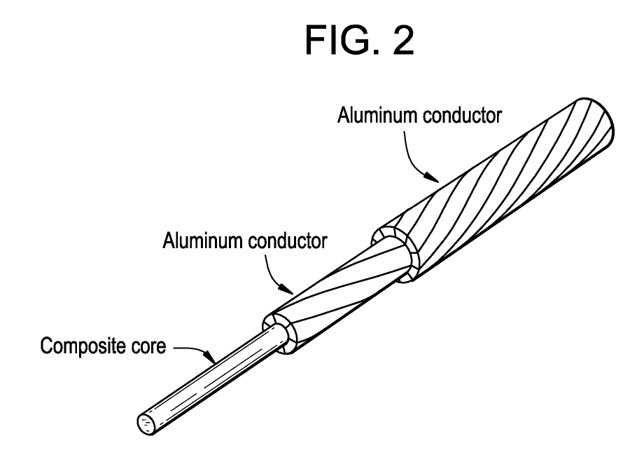

FIG. 2 shows a fiber-polymer composite-supported aluminum conductor.

The present invention is a fiber-polymer composite-supported overhead conductor comprising (a) a fiber-polymer composite core and (b) a tubular metal conductor. The tubular metal conductor is on the core and of such composition and soft temper that for all conductor operating temperatures, when the ambient temperature is above that at which ice and snow would accumulate on the conductor, substantially all mechanical tension resulting from the strung-overhead disposition of the conductor is borne by the fiber-polymer composite core, and the tubular metal conductor, if called upon to bear any consequential stress would, instead, elongate inelastically leaving such stress to be borne by the fiber-polymer composite core.

Preferably, the fiber-polymer composite core is a carbon fiber-reinforced polymeric composition comprising a carbon fiber and an epoxy resin. More preferably, the carbon fiber should be present in amount between about 70 weight percent to about 90 weight percent, more preferably, between about 75 weight percent and about 85 weight percent, and even more preferably, between about 78 weight percent and about 85 weight percent.

Preferably, the carbon fibers will have an elastic modulus greater than or equal to about 80 GPa. More preferably, the elastic modulus will greater than or equal to about 120 GPa. Furthermore, the carbon fibers will preferably have an ultimate elongation at failure over about 1.5 percent.

The epoxy resin may be a single resin or a mixture of more than one resin. Preferably, the epoxy resin should be present in an amount between about 10 weight percent and about 30 weight percent, more preferably, between about 15 weight percent and about 25 weight percent, and even more preferably, between about 15 weight percent and about 23 weight percent. Preferably, the epoxy resin is a thermoset epoxy resin. More preferably, the resin will have a glass transition temperature above about 150 degrees Celsius.

The carbon fiber-reinforced polymeric composition may further comprise chopped carbon fibers, carbon nanotubes, or both. When present, the carbon fibers or carbon nanotubes are preferably present in an amount between about 0.5 weight percent to about 10 weight percent, more preferably, between about 1 weight percent and 7 weight percent, and even more preferably, between about 1 weight percent and about 5 weight percent.

The carbon fiber-reinforced polymeric composition may further comprise a hardener. The amount of hardener present shall depend upon the amount of and type of epoxy used to prepare the composition.

The tubular metal conductor can be comprised on conductive metal. Preferably, the metal conductor will be aluminum. More preferably, the tubular aluminum conductor has an electrical conductivity no lower than 61 percent IACS.

An alternate embodiment of the present invention results in pre-forming continuous fibers into specific microstructures prior to the pultrusion process. These microstructures consist of axial fibers aligned in the longitudinal direction of the core as well as twisted fibers braided around the axial fibers with certain helix angles. It is believed that higher helix angles will usually increase the torsional strength.

Preferably and during the pultrusion process, the chopped carbon fibers or nanotubes are added to the epoxy resin.

Preferably, the ratio of axial fibers versus twisted fibers braided around the axial fibers is between about 50% and about 95%. It is believed that balance should be achieved between tensile strength and torsional/bending stiffness. As such, it is believed that care should be used with choosing the ratio because an increase in the ratio will increase tensile strength but yield a reduction in the torsional/bending strength of the composite core.

Preferably, the helix angle of the braided fibers should be in the range of about 15 degrees to about 55 degrees. As with the ratio of axial fibers to twisted fibers, it is believed that balance should be achieved between tensile strength and torsional/bending stiffness. As such, it is believed that care should be used with choosing the helix angle because an increase in the angle will decrease tensile strength but increase the torsional/bending strength of the composite core.

In yet another embodiment, the present invention is a fiber-polymer composite-supported conductor comprising (a) a fiber-polymer composite core; (b) a tubular conductor received upon the core and of such composition and soft temper that for all conductor operating temperatures substantially all mechanical tension resulting from the strung disposition of the conductor is borne by the fiber-polymer composite core, and the tubular conductor, if called upon to bear any consequential stress would, instead, elongate inelastically leaving such stress to be borne by the fiber-polymer composite core. The tubular conductor transmits electrical power or information.

In yet another embodiment, the present invention is a fiber-polymer composite core. The composite is comprised of one or more of the braided “macro-wires.” The “macro-wires” may or may not have a square cross section after the pre-forming process. Preferably, the “macro-wires” will be conformed into circular cross sections when they are pultruded though a circular die.

What is claimed is:

1. A fiber-polymer composite-supported overhead conductor comprising:
(a) a fiber-polymer composite core;
(b) a tubular metal conductor received upon said core and being of such composition and soft temper that for all conductor operating temperatures, when the ambient temperature is above that at which ice and snow would accumulate on said conductor, substantially all mechanical tension resulting from the strung-overhead disposition of the conductor is borne by the fiber-polymer composite core, and the tubular metal conductor, if called upon to bear any consequential stress would, instead, elongate inelastically leaving such stress to be borne by the fiber-polymer composite core.

2. The fiber-polymer composite-supported overhead conductor of claim 1 wherein the fiber-polymer composite core comprises microstructure-preformed continuous fibers.

3. The fiber-polymer composite-supported overhead conductor of claim 1 wherein the fibers of the fiber-polymer composite core are axially aligned in the longitudinal direction of the core.

4. The fiber-polymer composite-supported overhead conductor of claim 1 wherein the fibers of the fiber-polymer composite core are a first set of fibers axially aligned in the longitudinal direction of the core and a second set of fibers twisted braided around the first set of axial fibers.

5. The fiber-polymer composite-supported overhead conductor of claim 1 wherein the fiber-polymer composite core is comprised of at least one braided macro-wire.

6. The fiber-polymer composite-supported overhead conductor of claim 1 wherein the tubular metal conductor is an aluminum conductor.

7. The fiber-polymer composite-supported overhead conductor of claim 6 wherein the tubular aluminum conductor has an electrical conductivity no lower than 61 percent IACS

8. A fiber-polymer composite-supported conductor comprising:
(a) a fiber-polymer composite core;
(b) a tubular conductor received upon said core and being of such composition and soft temper that for all conductor operating temperatures substantially all mechanical tension resulting from the strung disposition of the conductor is borne by the fiber-polymer composite core, and the tubular conductor, if called upon to bear any consequential stress would, instead, elongate inelastically leaving such stress to be borne by the fiber-polymer composite core.

9. The fiber-polymer composite-supported conductor of claim 8 wherein the tubular conductor transmits electrical power.

10. The fiber-polymer composite-supported conductor of claim 8 wherein the tubular conductor transmits information.
